(19) United States
(12) Patent Application Publication
(10) Pub. No.: US 2017/0174140 A1
(43) Pub. Date: Jun. 22, 2017

(54) DRAWER ASSEMBLY WITH ANTI-SQUEAK AND RATTLE SYSTEM

(71) Applicant: FORD GLOBAL TECHNOLOGIES, LLC, Dearborn, MI (US)

(72) Inventors: Jose Alfredo Peregrina Loera, Mexico City (MX); Antonio Martinez Ilescas, San Mateo Atenco (MX); Francisco Ronquillo Melendez, Puebla (MX); Omar Antonio Ramirez Pavon, Portales Norte (MX)

(21) Appl. No.: 14/973,142

(22) Filed: Dec. 17, 2015

(51) Int. Cl. B60R 7/04; A47B 88/04; A47B 88/00

(52) U.S. Cl. CPC B60R 7/04; A47B 88/0003; A47B 88/0455

(57) ABSTRACT

A drawer assembly is provided. That drawer assembly includes a bezel and a drawer carried on the bezel. The drawer is displaceable between a closed position and an opened position. A lock assembly secures the drawer in the closed position. The lock assembly includes a locking feature on the drawer and a catch in the bezel. A first spring feature on the bezel biases the locking feature tightly against the catch when the drawer is in the closed position so as to mitigate squeaks, rattles and vibrations.

### TECHNICAL FIELD

This document relates generally to the motor vehicle equipment field and, more particularly, to a drawer assembly that is relatively inexpensive to produce and that incorporates a very effective system for mitigating squeaks and rattles.

### BACKGROUND

Drawer assemblies incorporating a bezel and a cooperating drawer that are both molded from a plastic or composite material are well known in the art. Such assemblies typically incorporate two opposed guide tracks or support channels along the bezel and two opposed slides on the drawer to provide for smooth sliding action of the drawer in the bezel. Typically such a drawer assembly also includes a locking mechanism to secure the drawer in a closed position.

Due to the nature of the sliding and locking mechanisms, the drawer and bezel must be molded with clearances sufficient to accommodate expected manufacturing tolerances. Such clearances or gaps may lead to undesirable squeaks and rattles when the drawer system is finally assembled.

This document relates to a drawer assembly incorporating an integral system to mitigate squeaks and rattles in a simple and very cost effective manner.

### SUMMARY

In accordance with the purposes and benefits described herein, a new and improved drawer assembly is provided. That drawer assembly comprises a bezel and a drawer. The drawer is carried on the bezel and is displaceable between a closed position and an opened position. The drawer assembly also includes a lock assembly for securing the drawer in a closed position. That lock assembly includes a locking feature on the drawer and a catch on the bezel. Further, the drawer assembly includes a first spring feature on the bezel for biasing the locking feature tightly against the catch when the drawer is in the closed position.

The first spring feature may be an integral, molded part of the bezel. In one possible embodiment, the first spring feature engages the rear wall when the drawer is in the closed position, biasing the drawer in a first direction toward an opened position but for engagement of the locking feature with the catch.

In one possible embodiment, the lock assembly includes a second spring feature biasing the locking feature in a second direction toward the catch. That second direction may be substantially perpendicular to the first direction. In such an embodiment, the locking feature may be captured between the second spring feature and the catch when the drawer is in a closed position. That second spring feature may also be an integral, molded part of the bezel just like the first spring feature.

In accordance with an additional aspect, the drawer assembly may be described as comprising a bezel and a first integral spring feature made from a single piece of material as well as a drawer carried on the bezel. That drawer is positively held by the first integral spring feature to prevent squeaking and rattling when the drawer is in the closed position.

The bezel may include a second integral spring feature. The first integral spring feature functions to bias the drawer in a first direction while the second integral spring feature functions to bias the drawer in a second direction substantially perpendicular to the first direction.

Further, the drawer may include a locking feature and the bezel may include a catch. When in the closed position the first integral spring feature and the second integral spring feature positively hold the locking feature against the catch to secure the drawer into the closed position and simultaneously mitigate squeaks and rattles.

In accordance with yet another aspect, a method is provided of mitigating squeaks and rattles of a drawer and a bezel. That method may be described as comprising the step of positively biasing a locking feature on the drawer into engagement with a catch on the bezel when the drawer is in a closed position. This is done by means of a first spring feature integrally formed as a part of the bezel.

The method may further include positively biasing the locking feature on the drawer into engagement with the catch on the bezel when the drawer is in the closed position by means of a second spring feature integrally formed as a part of the bezel. In such an embodiment, the first spring feature may positively bias the locking feature in a first direction while the second spring feature may positively bias the locking feature in a second direction wherein the first and second directions are substantially perpendicular to one another.

Still further, the method may include the step of engaging the drawer adjacent a bottom rear corner with the first spring feature. In addition, the method may include the step of engaging the locking feature with the second spring feature.

In the following description, there are shown and described several preferred embodiments of the drawer assembly. As it should be realized, the drawer assembly is capable of other, different embodiments and its several details are capable of modification in various, obvious aspects all without departing from the drawer assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the drawer assembly and together with the description serve to explain certain principles thereof. In the drawing figures:

FIGS. 1A and 1B are respective schematic side elevational illustrations of the drawer assembly in the closed position and the opened position.

FIG. 2 is a detailed rear perspective view of the drawer assembly illustrating the two resilient ears projecting from the main body of the bezel that form the first integral spring feature of the drawer assembly.

FIG. 3 is a schematic side elevational view of the drawer assembly illustrating how the first and second integral spring features provided on the bezel function to bias the locking feature on the drawer securely in the cooperating catch on the bezel thereby mitigating any squeaks and rattles.

Reference will now be made in detail to the present preferred embodiments of the drawer assembly, examples of which are illustrated in the accompanying drawing figures.

### DETAILED DESCRIPTION

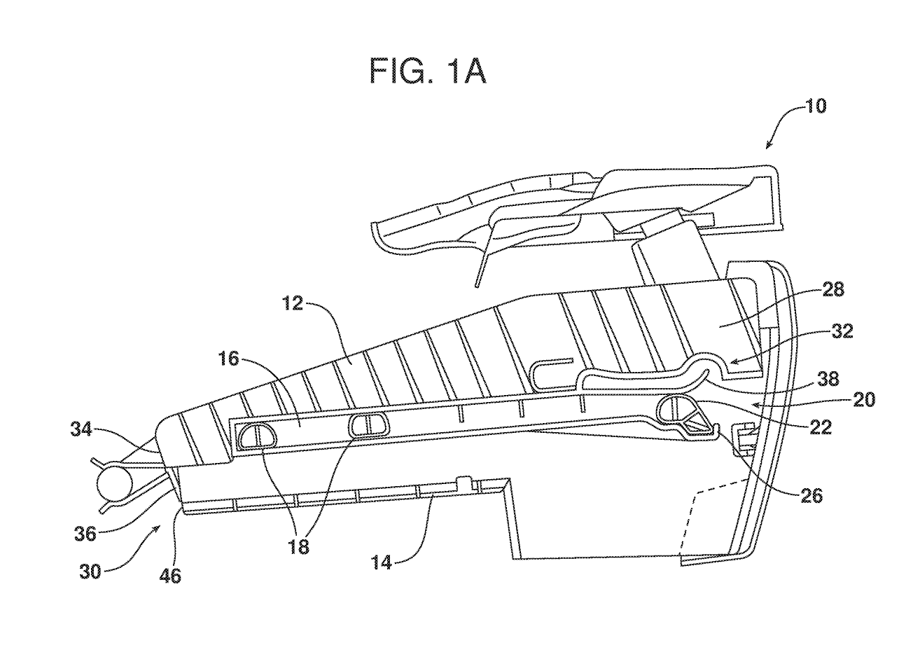

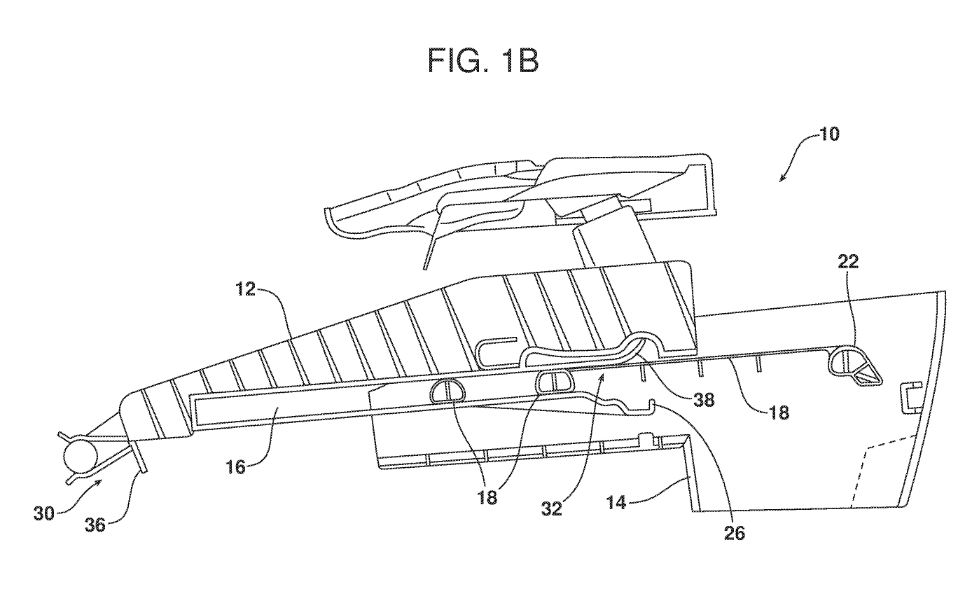

Reference is now made to FIGS. 1A, 1B, 2 and 3 illustrating the drawer assembly 10. That drawer assembly 10 includes a bezel 12 and a drawer 14. The drawer 14 is displaceable between a closed position illustrated in FIG. 1A and an open position illustrated in FIG. 1B.

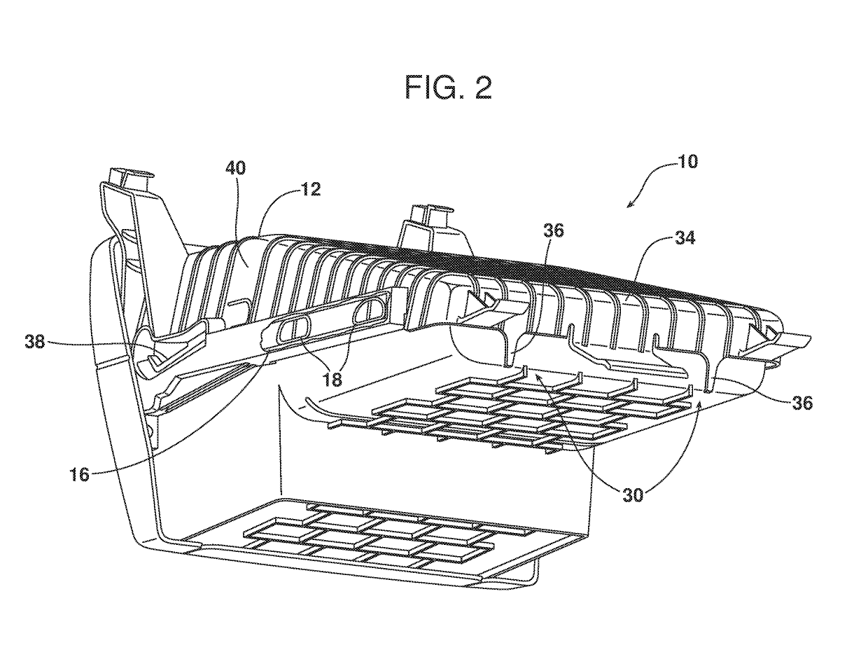

More specifically, the bezel 12 includes two opposed guide channels 16 and the drawer 14 includes two opposed slides 18 received in those opposed guide channels to guide the drawer as it slides with respect to the bezel between the open and closed positions. One guide rail 16 and one slide 18 are illustrated in FIGS. 1A and 1B on the respective right sides of the bezel and drawer. The other opposed guide channel 16 and opposed slide 18 are provided on the respective left sides of the respective bezel 12 and drawer 14 and are partially visible in FIG. 2.

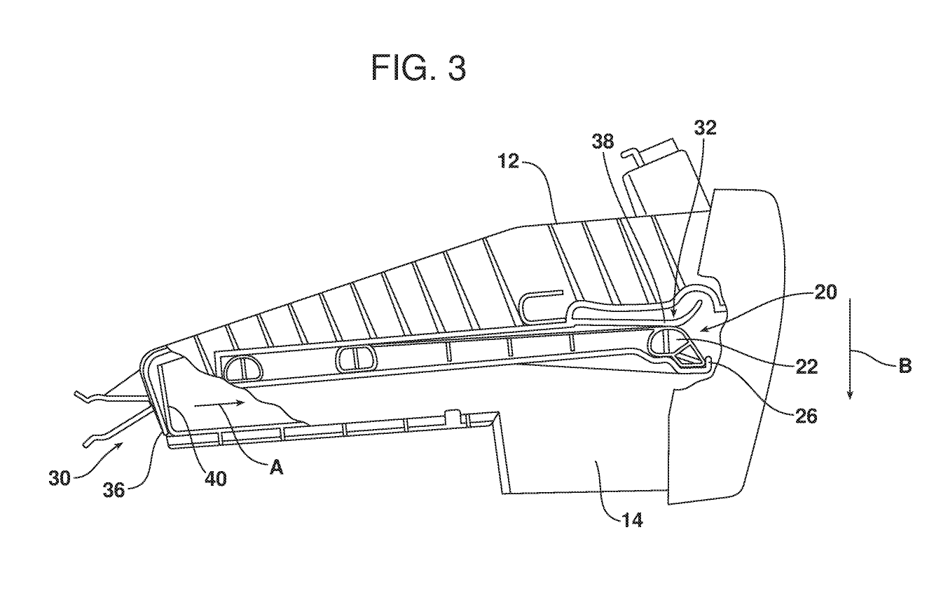

The drawer assembly 10 also includes a lock assembly generally designated by reference numeral 20. The lock assembly 20 secures the drawer 14 in the closed position within the bezel 12. As illustrated in FIG. 3, the lock assembly 20 includes a locking feature 22 on the right side 24 of the drawer 14 and a cooperating catch 26 on the right side 28 of the bezel 12. A second cooperating locking feature 22 and catch 26 are provided on the left sides of the respective drawer 14 and bezel 12 but are not visible in FIG. 2. This second cooperating lock assembly 20 is a mirror image of the one illustrated in FIG. 3.

The bezel 12 also includes a first spring feature 30 and a second spring feature 32. Either or both spring features 30, 32 may be integral with and molded as a part of the bezel 12. Thus, the main body 34, the first spring feature 30 and the second spring feature 32 of the bezel 12 may all be molded as a single piece or part from an appropriate polymer or composite material.

More specifically as best illustrated in FIG. 2, the first spring feature 30 of the illustrated embodiment comprises two resilient ears or elements 36 that depend from or project downwardly from the main body 34. In contrast, as shown in FIGS. 1A, 1B, 2 and 3, the second spring feature 32 in the illustrated embodiment comprises two resilient spring elements 38: one at each side 28, 40 of the bezel 12 overlying the two opposed catches 26. As should be appreciated, when the drawer 14 is fully closed, the locking features 22 at each side of the drawer 14 are captured between the two resilient elements 38 of the second spring feature 32 and the two catches 26.

In order to provide the necessary clearance to accommodate manufacturing tolerances, the two opposed guide channels 16 are longer than the two opposed slides 18 and locking features 22 so as to provide a slight gap. In the absence of the first spring feature 30, this can lead to a loose fit between the drawer 14 and the bezel 12 resulting in squeaking and rattling. As will become apparent in the following description, the first spring feature 30 eliminates the play between the drawer 14 and bezel 12 when the drawer is in the closed position and functions with the second spring feature 32 to mitigate squeaking and rattling.

More specifically, when the drawer 14 is fully closed in the bezel 12, the rear wall 40 of the drawer 14 engages and deflects the two resilient ears/elements 36 of the first spring feature 30. As a result, the resilient ears/elements 36 bias the drawer 14 in a first direction (note action arrow A in FIG. 3) toward an open position but for engagement of the locking features 22 in the catches 26. As should be appreciated, this engagement is ensured by the resilient elements 38 of the second spring feature 32 which bias the drawer 14 downwardly in a second direction (note action arrow B) and is substantially perpendicular to the first direction. As should be appreciated, the biasing force in the two directions A, B ensures that the locking features 22 are received at the bottom of the catches 26. Thus, the drawer 14 is positively held against the bezel 12 by a positive force that mitigates squeaks, vibrations and rattles.

When one wishes to open the drawer 14 one merely grasps the handle 42 on the front wall 44 of the drawer, lifts the drawer 14 slightly against the biasing force of the resilient elements 38 until the locking features 22 are free of the catches 26 and then pulls the drawer 14 open.

As should be appreciated, a method of mitigating squeaks and rattles of a drawer in a bezel is also provided. That method includes positively biasing a locking feature 22 on the drawer 14 into engagement with a catch 26 on the bezel 12 when the drawer is in a closed position by means of a first spring feature 30 integrally formed as a part of the bezel. Further, that method may include the step of positively biasing the locking feature 22 on the drawer 14 into engagement with the catch 26 on the bezel 12 when the drawer is in the closed position by means of a second spring feature 32 also integrally formed as a part of the bezel.

As should be appreciated from reviewing FIG. 3, the first spring feature 30 positively biases the drawer 14 and, therefore, the locking feature 22 in a first direction (note action arrow A) while the second spring feature 32 positively biases the drawer and the locking feature in a second direction (note action arrow B) wherein the first direction is substantially perpendicular to the second direction.

Further, the method may include the step of engaging the drawer 14 adjacent a bottom rear corner 46 with the first spring feature 30 as well as the step of engaging the locking feature 22 with the second spring feature 32. In this way, the locking feature 22 is securely held at the bottom of the catch 26 with the positive biasing force provided by the two spring features 30, 32 functioning to mitigate any vibration, squeak or rattle of the drawer 14 and the bezel 12.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A drawer assembly, comprising:
a bezel;
a drawer, on said bezel, displaceable between a closed position and an opened position;
a lock assembly securing said drawer in said closed position, said lock assembly, including a locking feature on said drawer and a catch on said bezel; and
a first spring feature on said bezel for biasing said locking feature tightly against said catch when said drawer is in said closed position to prevent squeaking and rattling, wherein said first spring feature is an integral, molded part of said bezel.

2. (canceled)

3. The drawer assembly of claim 1, wherein said drawer includes a rear wall and a second spring feature engages said rear wall when said drawer is in said closed position, biasing said drawer in a first direction toward an opened position but for engagement of said locking feature with said catch.

4. The drawer assembly of claim 3, wherein said second spring feature biases said locking feature in a second direction toward said catch.

5. The drawer assembly of claim 4, wherein said second direction is substantially perpendicular to said first direction.

6. The drawer assembly of claim 5, wherein said locking feature is captured between said second first spring feature and said catch when said drawer is in said closed position.

7. The drawer assembly of claim 6, wherein said second spring feature is an integral, molded part of said bezel.

8. The drawer assembly of claim 7, wherein said second spring feature comprises two resilient ears projecting from a main body of said bezel.

9. The drawer assembly of claim 8, wherein said bezel includes two opposed guide channels and said drawer includes two opposed slides received in said two opposed guide channels.

10. The drawer assembly of claim 1, wherein said drawer includes a rear wall and a second spring feature engages said rear wall when said drawer is in said closed position, biasing said drawer in a first direction toward an opened position but for engagement of said locking feature with said catch.

11. The drawer assembly of claim 10, wherein said second spring feature biases said locking feature in a second direction toward said catch.

12. The drawer assembly of claim 11, wherein said second direction is substantially perpendicular to said first direction.

13. A drawer assembly, comprising:
a bezel and a first integral spring feature made from a single piece of material;
a drawer carried on said bezel, said drawer being positively held by said first integrated spring feature to prevent squeaking and rattling when said drawer is in a closed position.

14. The drawer assembly of claim 13 wherein said bezel includes a second integral spring feature, said first integral spring feature biasing said drawer in a first direction and a said second integral spring feature biasing said drawer in a second direction substantially perpendicular to said first direction.

15. The drawer assembly of claim 14, wherein said drawer includes a locking feature and said bezel includes a catch, and said first integral spring feature and said second integral spring feature positively holding said locking feature against said catch when said drawer is in said closed position.

16. A method of mitigating squeaks and rattles of a drawer in a bezel, comprising:
positively biasing a locking feature on said drawer into engagement with a catch on said bezel when said drawer is in a closed position by means of a first spring feature integrally formed as a part of said bezel.

17. The method of claim 16, further including positively biasing said locking feature on said drawer into engagement with said catch on said bezel when said drawer is in said closed position by means of a second spring feature integrally formed as a part of said bezel.

18. The method of claim 17, wherein said first spring feature positively biases said locking feature in a first direction and said second spring feature positively biases said locking feature in a second direction wherein said first direction is substantially perpendicular to said second direction.

19. The method of claim 18, including engaging said drawer adjacent a bottom rear corner with said first spring feature.

20. The method of claim 19, including engaging said locking feature with said second spring feature.
